(19) United States
(12) Patent Application Publication
(10) Pub. No.: US 2026/0009917 A1
(43) Pub. Date: Jan. 8, 2026

(54) LOW FREQUENCY ANOMALY ATTRIBUTE DETECTION

(71) Applicant: SCHLUMBERGER TECHNOLOGY CORPORATION, Sugar Land, TX (US)

(72) Inventors: Ahmed Adnan AQRAWI, Tananger (NO); Bilal Ahmed BHATTI, Tananger (NO); Abdul Razzaq AQRAWI, Tananger (NO); Maalidefaa Moses TANTUOYIR, Tananger (NO)

(21) Appl. No.: 19/117,646

(22) PCT Filed: Oct. 2, 2023
(86) PCT No.: PCT/US2023/075712

§ 371 Date: Apr. 2, 2025

Related U.S. Application Data
(60) Provisional application No. 63/412,778, filed on Oct. 3, 2022.

(51) Int. Cl. G01V 1/30

(52) U.S. Cl. CPC G01V 1/302; G01V 2210/43

(57) ABSTRACT

Seismic data for a subsurface region is obtained. Individually, for each factor of multiple factors, a corresponding set of factor cubes specific to the factor is generated to obtain sets of factor cubes. Each factor cube includes cells having a value for the factor cube that is for a particular location in the subsurface region. An unsupervised machine learning clustering model is executed on the sets of factor cubes to determine a corresponding weight for each factor. According to the corresponding weight, the sets of factor cubes are aggregated to generate an aggregated cube, which is presented.

### CROSS REFERENCE TO RELATED APPLICATIONS

This application is a non-provisional application of, and thereby claims benefit to, U.S. Provisional Application Ser. No. 63/412,778 filed on Oct. 3, 2022.

### BACKGROUND

Geological and geophysical (G&G) exploration may be performed in order to identify one or more subsurface hydrocarbon deposits (such as oil or natural gas). Once a subsurface hydrocarbon deposit is identified, a drilling operation might be performed to retrieve the identified hydrocarbon resources.

A challenge exists in finding the hydrocarbon reservoirs in the subsurface. One way to find hydrocarbon reserves is to use seismic data. However, different reservoirs may have different responses to the seismic signals. Namely, different reservoirs may behave differently. For example, a low frequency anomaly may differ between subsurface regions. A low frequency anomaly occurs when a seismic wave propagates through the subsurface and encounters fluids, the seismic wave has an amplitude increase and a reduction in frequency. However, the low frequency anomaly may not appear the same way in each subsurface region. Thus, although low frequency anomalies may be indicative of the presence of hydrocarbons, the ability to identify low frequency anomalies is a challenge.

### SUMMARY

In general, in one aspect, low frequency anomaly attribute detection generally relates to obtaining seismic data for a subsurface region. Individually, for each factor of multiple factors, a corresponding set of factor cubes specific to the factor is generated to obtain sets of factor cubes. Each factor cube includes cells having a value for the factor cube that is for a particular location in the subsurface region. An unsupervised machine learning clustering model is executed on the sets of factor cubes to determine a corresponding weight for each factor. According to the corresponding weight, the sets of factor cubes are aggregated to generate an aggregated cube, which is presented.

Other aspects of the invention will be apparent from the following description and the appended claims.

### BRIEF DESCRIPTION OF DRAWINGS

FIG. 1 shows a diagram of a system in accordance with one or more embodiments.

FIG. 2 is a flowchart of a method in accordance with one or more embodiments.

FIG. 3, FIG. 4, FIG. 5, and FIG. 6 are examples cross sections of factor cubes for factors processed in accordance with one or more embodiments.

FIG. 7 shows an example cross section of an aggregated cube in accordance with one or more embodiments.

FIG. 8 shows an example in accordance with one or more embodiments.

FIG. 9.1 and FIG. 9.2 show a computing system and network environment, in accordance with one or more embodiments.

Like elements in the various figures are denoted by like reference numerals for consistency.

### DETAILED DESCRIPTION

In general, embodiments are directed to training and using an unsupervised machine learning clustering model to learn weights between factors indicating a presence of hydrocarbons. In particular, one or more embodiments relate to changing seismic data obtained from seismic sensors to multiple factor cubes, where an individual factor cube exists for each factor. Embodiments then learn the weights to apply to the factor cubes for when the factor cubes are aggregated. The weights are learned through a machine learning clustering algorithm that is applied to the set of factor cubes. The weights correspond to how much each factor is indicative of the presence of hydrocarbons in the subsurface and are specific to the particular subsurface. After learning the weights, the weights are used to aggregate the factor cube and generate a resulting aggregated cube. The resulting aggregated cube highlights the locations of hydrocarbons. The factors may include low frequency anomalies, flat spots in the subsurface, bright spots in the subsurface, and fractures.

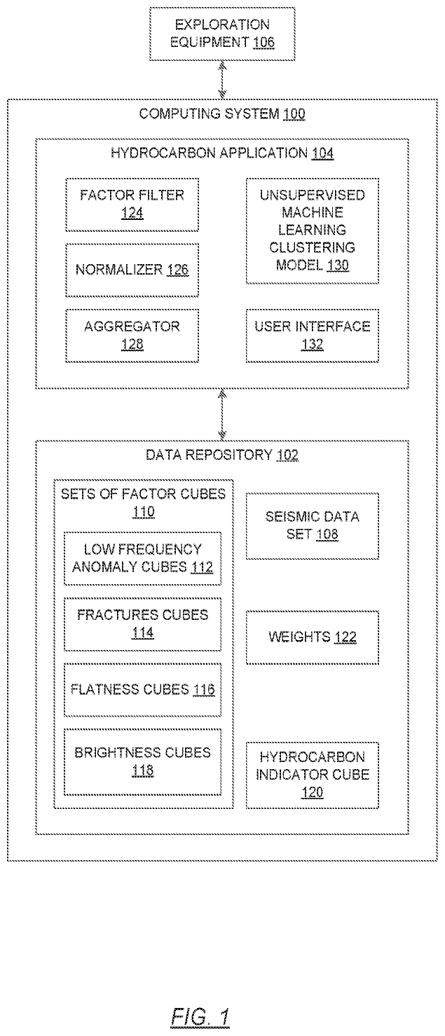

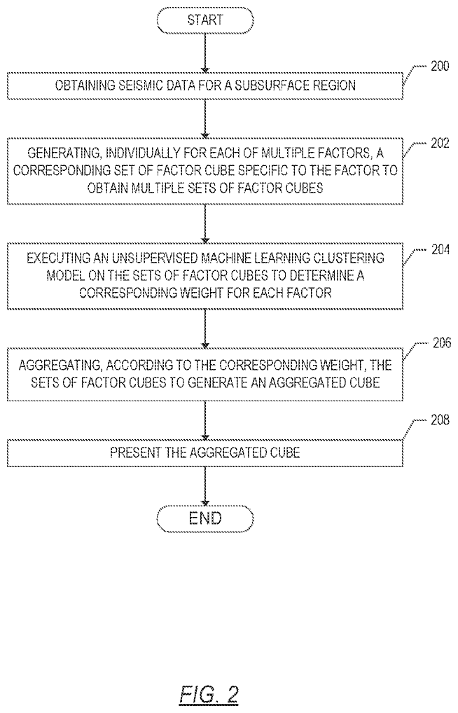

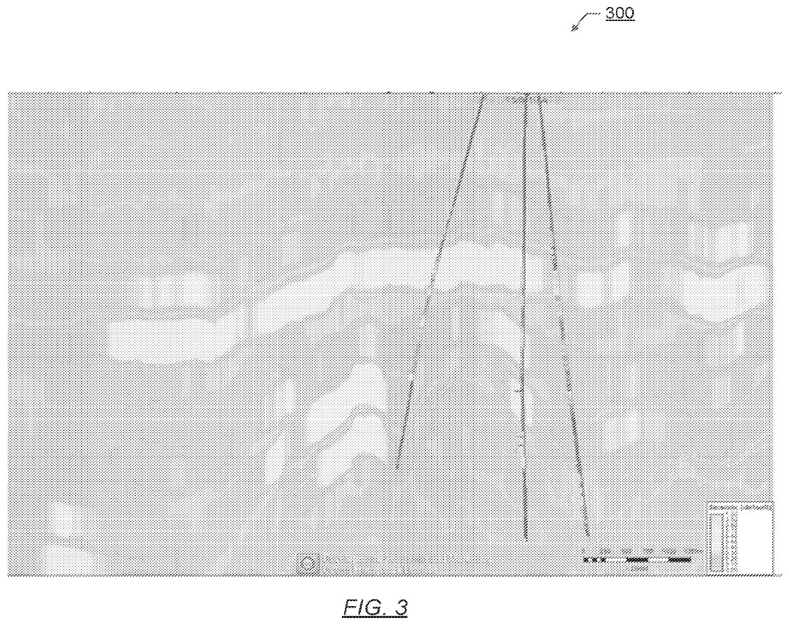

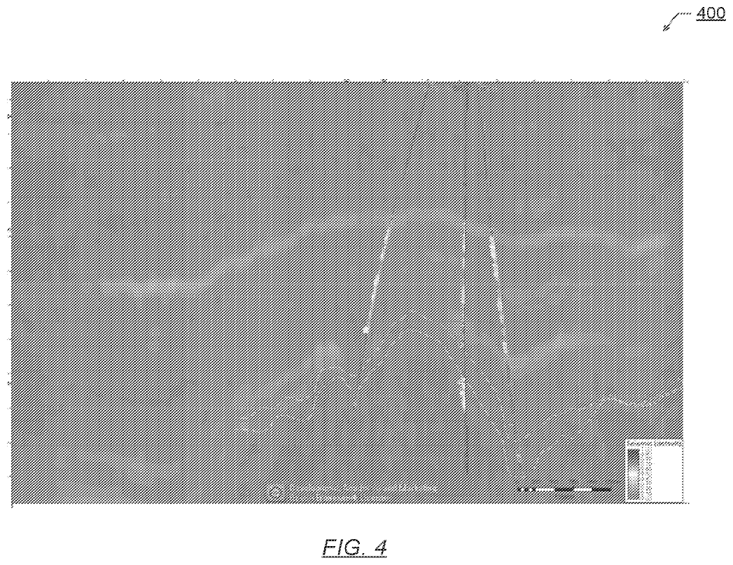

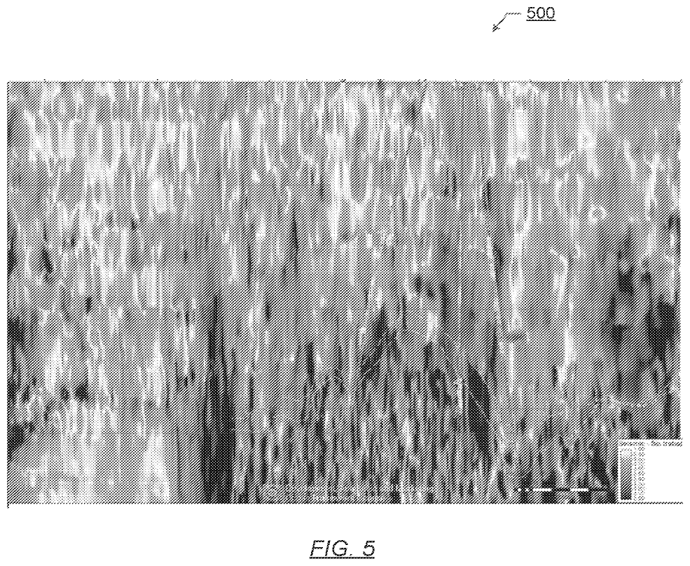

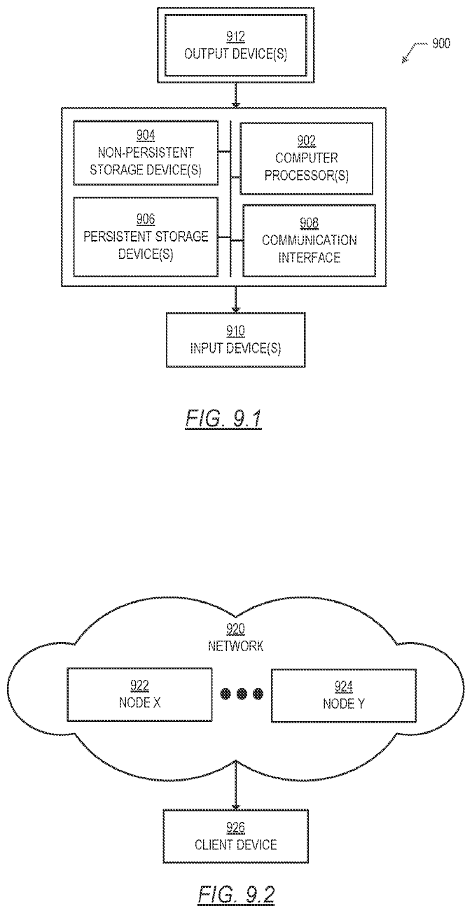

FIG. 1 shows a computing system (100) that may be used to accomplish the one or more embodiments, such as the method shown in FIG. 2. The computing system shown in FIG. 1 may be used to generate the factor cubes with cross sections shown in FIG. 3 through FIG. 7. The computing system (100) includes a non-transitory computer readable storage medium. The computing system (100) may be one or more servers or other computers and processors, such as those shown in FIG. 9.1 and FIG. 9.2. The computing system (100) includes a data repository (102) and a hydrocarbon application (104). Each of the components of the computing system (100) is discussed below.

The data repository (102) stores a seismic data set (108). The seismic data set is a set of seismic data obtained by one or more sensors (which may be part of the exploration equipment (106)). The seismic data may be part of a seismic survey whereby a seismic source sends seismic waves through the subsurface region. Resulting signals as the seismic waves reflect off of different subsurface layers are transmitted to seismic receivers. The seismic data set (108) may be time series data.

The data repository includes sets of factor cubes (110). The sets of factor cubes (110) are cubes of seismic data defined for a particular factor. Each cube is a three dimensional map of a subsurface region. Namely, a cube may be a three dimensional set of cells, whereby each cell corresponds to a corresponding location in the subsurface region. For example, a one-to-one mapping may exist between cells. Although the term, “cube,” is used, the dimensions of the cube may be unequal in different directions. Each cell stores a value that is generated for a particular factor. A factor is the attribute of the subsurface and seismic data that can be indicative of the presence of hydrocarbons. The sets of factor cubes may include low frequency anomaly cubes (112), fractures cubes (114), flatness cubes (116), and bright spots cubes (118). Although four factor cubes are presented, other cubes may be included without departing from the scope of the claims.

Each factor cube is generated by processing the seismic data for a particular volume attribute in order to highlight cells exhibiting the factor. Highlighting means that the values in the cells are proportional to the extent that the corresponding location exhibits the factor as derived from the seismic data. For example, if the factor is a fracture, the cells that are for locations of a detected fracture may have values 1 or close to 1, while other cells in which a fracture is not detected may have values close to 0.

A set of factor cubes may be formed by performing different processing techniques on the seismic data and varying the parameters of the processing to highlight the factor. Each of the different processing techniques and parameters are defined to highlight the particular factor. Thus, a specific factor cube in the set of factor cubes is a combination of a specific processing technique and a set of parameters for performing the processing technique. By varying the processing technique and/or the parameters, new factor cubes for a particular factor may be created and added to the set of factor cubes for the particular factor. The sets of factor cubes are described below.

Each low frequency anomaly cube in a set of low frequency anomaly cubes (112) is a cube that shows low frequency anomalies in the subsurface region. The low frequency response is a portion of the frequency components of the seismic data. The term “low” may be quantified as being in a pre-determined range of frequencies in the frequency components, such as but not limited to less than 15 Hz. Low frequency anomalies occur when the seismic signal passes through a gas or liquid causing the frequency of the seismic wave to be reduced to a lower frequency. Cells corresponding to locations with low frequency response may be highlighted in each low frequency anomaly cube of the set of low frequency anomaly cubes (112).

Each fracture cube in the set of fracture cubes (114) is a cube in which the fractures in the subsurface are made more prominent. In the fracture cube, the volume attribute is the detected fractures in the seismic volume. Specifically, the existence of fracture in the cube may be indicative of hydrocarbon bearing zones. Cells corresponding to locations with detected fractures as detected in the seismic data may be highlighted in each fracture cube. A fracture cube may also be referred to as a secondary porosity cube. In such a scenario, secondary porosity refers to the consideration of smaller fractures that may be indicative of the presence of hydrocarbons rather than larger fractures.

Each flatness cube in the set of flatness cubes (116) is a cube in which cells corresponding to flat spot locations are more prominent than the remaining cells. The flat spot is a flatness of reflectors in the seismic data. A reflector refers to a seismic reflector, formation top, or lithological barrier. In principle, a reflector represents the distinguishable boundary of acoustic impedance contrast in the subsurface. The term “acoustic impedance” is defined as the density multiplied by the velocity, of layers in the subsurface. Seismic reflectors in a seismic section represent acoustic impedance contrast. Estimating the dip of seismic reflectors could represent any flat surfaces or flat spots of underground formations. Flat spots are flat reflectors in seismic data that are widely used in oil and gas exploration and may have oil, gas, and/or water contents.

Each brightness cube in the set of brightness cubes (118) is a cube in which the high amplitude energy response of seismic signals. The high-amplitude energy response represents the amplitudes of the frequency components of the seismic data. The term “high” is relative to lower amplitude ranges of measurements, or within a pre-determined amplitude range. The high amplitudes may depend distinctly on each dataset's amplitude range at certain frequencies. The brightness cube has the volume attribute of higher amplitudes being highlighted in each of the brightness cubes (118). Cells that correspond to locations not having a high amplitude energy response threshold may have a zero value. The remaining cells may have values proportional to the degree to which the locations of the cells exhibit the high amplitude energy response.

Continuing with the data repository (102), a hydrocarbon indicator cube (120) is a cube in which each cell's value is a cellwise aggregation of the factor cubes (110). Namely, each cell in the hydrocarbon indicator cube (120) is a combination of the values of the cells at the same position in the factor cubes (110). Thus, the overall value is a hydrocarbon indicator for the location.

The degree to which each factor cube (110) affects the hydrocarbon indicator cube (120) is set by weights (122). The weights are adjustment values to account for the fact that each factor may not be equally indicative of hydrocarbons. The weights are dynamic and specific to a particular subsurface region. Further, the weights are learned through the machine learning clustering algorithm described below.

Continuing with FIG. 1, the hydrocarbon application (104) is configured to detect the presence of hydrocarbons using the seismic data set. The hydrocarbon application (104) is software configured to execute on the computer system. The hydrocarbon application (104) includes a factor filter (124), a normalizer (126), an aggregator (128), an unsupervised machine learning clustering model (130), and a user interface (132).

The factor filter (124) is configured to analyze the seismic data and generate sets of factor cubes (110). Multiple factor filters may be applied for the same factor. Each factor filter may perform a different processing technique based on input parameters. Further, different third party factor filters may be used. The normalizer (126) is configured to normalize the factor cubes (110) to have the cells of the factor cubes be in the same range of values. Normalized factor cubes map the values of the cells to be in the same range. The aggregator (128) is configured to aggregate the factor cubes based on the weights (122) and generate a hydrocarbon indicator cube (120).

The unsupervised machine learning clustering model (130) is a machine learning model that is configured to perform clustering on the factor cubes (110) and learn the weights (122). The unsupervised machine learning clustering model (130) does not aggregate the sets of factor cubes (110). Rather, the unsupervised machine learning clustering model learns the weights without a labeled training data set. An example of an unsupervised machine learning clustering model is an agglomerative model that is further trained to generate weights based on the outcome of agglomerative clustering.

The user interface (132) is configured to present the hydrocarbon indicator cube (120). Further, the user interface (132) may be configured to interface with the user.

FIG. 2 shows a flowchart in accordance with one or more embodiments. While the various blocks in the flowcharts are described sequentially, some of the blocks may be performed in different order, combined, or omitted.

In Block 200, seismic data for a subsurface region is obtained. The seismic data is obtained by performing a seismic survey of a region using seismic sensors. Preprocessing of the seismic data may be performed to remove artifacts and other noise.

In Block 202, individually, for each of the multiple factors, a corresponding set of factor cubes specific to the factor is generated to obtain multiple sets of factor cubes. In one or more embodiments spectral decomposition is performed on the seismic data to transform the seismic data from a time domain to a frequency domain. For different factors, different types of filtering are performed. The filtering may be performed by corresponding volume attribute processes that are specific to the volume attribute. For example, a fracture cube may be generated by a process specifically configured to identify fractures. Similarly, brightness cubes and low frequency anomaly cubes may be generated by applying corresponding amplitude thresholds and frequency thresholds, respectively, to the seismic data. Multiple processing techniques are performed to generate the set of factor cubes for the factor. Each processing technique has a corresponding set of parameters. Thus, several factor cubes are generated for the same factor.

The various factor cubes may be normalized. The process of normalization transforms each value of each cube separately from the values of the other cubes. Normalization may be performed by, for each factor cube, determining the minimum and maximum values of the cells of the factor cube. The difference between the minimum and maximum value is calculated to obtain a first result. Next, independently, for each cell, the difference between the current value of the cell and the minimum value of the call is calculated to obtain a second result. The second result is divided by the first result to obtain a normalized value for the cell. The process is repeated for each cell in accordance with one or more embodiments.

In Block 204, an unsupervised machine learning clustering model may be executed on the sets of factor cubes to determine the corresponding weights for each factor. In one or more embodiments, the unsupervised machine learning clustering algorithm is performed independently for each set of factor cubes. Namely, for each set of factor cubes, the clustering is performed for the particular set. The set of factor cubes for a particular factor prior to the clustering may be referred to as an initial set of factor cubes or as an initial corresponding set of factor cubes that correspond to the cluster. The factor cubes in the initial set of factor cubes may be referred to as initial factor cubes.

In one or more embodiments, the unsupervised machine learning clustering model is an agglomerative clustering model. In the agglomerative clustering model, initially, each item is an individual cluster. Namely, at the outset, each item is its own cluster. Next, an iterative process is performed. The iterative process merges clusters based on a degree of similarity between the clusters. The result is a new cluster with merged values. The clusters forming the merged clusters are directly linked in a dendrogram. This process is repeated until a stopped condition is reached.

In one or more embodiments, the agglomerative clustering may be performed independent of other sets of factor cubes on a set of factor cubes as follows. Iteratively, until a stop condition is reached, the following operations are performed. At least two factor cubes in the set of factor cubes are combined based on a determined similarity between the at least two factor cubes to form a combined cube. Determined similarity is based on a function of the values and the position of the cells having the values in the factor cubes.

The combination forms a cluster of at least two factor cubes. In the cluster, cellwise aggregation is performed. Namely, separately, for each cell, the values of the cell in the at least two factor cubes may be aggregated together to form an aggregated value. The aggregated value is stored in the cell in the combined cube. The process is repeated for each cell to obtain the values of the cells for the combined cube. The combined cube is then normalized to create a normalized cube. In one or more embodiments, the normalization changes the values of the combined cube to be values between zero and one. Thus, the normalized cube may then be compared against the other factor cubes in the set of factor cubes. The at least two factor cubes that form the combined cube are replaced by the normalized cube. Namely, the normalized cube is added as a new factor cube to the set of factor cubes. Further, the at least two factor cubes that are combined are linked in a dendrogram. The iterative process is repeated until a stop condition is reached. The stop condition is a function of a degree of similarity between factor cubes in the set of factor cubes. For example, the stop condition may be that the factor cubes in the set are determined to no longer have a level of similarity so as to be combinable.

The result of the agglomerative clustering is a normalized cube for the factor and a dendrogram. At the lowest level of the dendrogram are the initial set of factor cubes. The weight for the factor is the total number of initial factor cubes that form the normalized factor cube as in the dendrogram divided by the total number of initial factor cubes. Stated another way, the weight is the number of initial factor cubes that are combined to form the normalized cube divided by the total number of initial factor cubes for the factor.

In Block 206, according to the corresponding weight, the sets of factor cubes are aggregated to generate an aggregated cube. For each factor, the normalized cube may be used to perform the aggregation. The remaining factor cubes in the sets of factor cubes may be ignored. In one or more embodiments, the aggregation individually combines the value of each cell in the normalized cube with the weight of the factor to obtain a weighted normalized value for the cell. Then, the weighted normalized values of the cells in the same position of different factor cubes are combined to obtain an aggregated value for the same position in the aggregated factor cube. Stated another way, the aggregation is a cellwise weighted aggregation of the normalized factor cubes (i.e., normalized cubes). One way to perform the aggregation is a cellwise weighted summation. However, other formulas may be used without departing from the scope of the claims. By way of an example, the following equation may be used: V_{A,x,y,z}=Σ_{f∈F}(W_{f}·V_{f,x,y,z}). In the equation, V is the value of the cell at position x, y, z in the cube, A is the aggregation cube, f is a particular factor cube, and F is the set of factor cubes.

In Block 208, the aggregation cube is presented. Because the weights are learned and the aggregation cube is a combination of different hydrocarbon indicators, the values of the cells of the aggregation cube are indicative of the presence of hydrocarbons at the locations for a particular subsurface region. The aggregation cube may be presented in the user interface. Specifically, the aggregation cube may focus the user on particular locations. One or more embodiments may further perform drilling or production operations to acquire hydrocarbons from the location. Drilling operations may be performed to drill new wells to the location. Production operations may be performed to acquire hydrocarbons from the newly drilled wells or existing wells.

FIG. 3, FIG. 4, FIG. 5, and FIG. 6 are examples of cross sections of factor cubes for factors processed in accordance with one or more embodiments. FIG. 3, FIG. 4, FIG. 5, and FIG. 6 may be the normalized cubes generated from the corresponding set of factor cubes. Specifically, FIG. 3 shows an example cross section of a low frequency anomaly cube (300). The highlighted sections of FIG. 3 correspond to lower frequencies as compared to surrounding regions.

FIG. 4 shows an example of a cross section of a brightness factor cube (400). FIG. 4 shows an enhanced amplitude seismic section of Inline 10161. White to darker shades represents high amplitudes. The reflectors marked show the top and base of Hugin Fm, respectively. The highlighted sections of FIG. 4 correspond to higher amplitudes as compared to surrounding regions.

FIG. 5 shows an example of a cross section of a flatness factor cube (500). In FIG. 5, dip calculations are modified to represent flatness of the cube. A trace is used to trace the cross correlation method for the computation. White represents the flatness of reflectors. The reflectors marked show the top and base of Hugin Fm, respectively.

FIG. 6 shows an example of a cross section of a fracture factor cube (600). In the fracture factor cube (600), discontinuities of reflectors are highlighted. Black to lighter values represents faulting in the area. The reflectors marked show the top and base of Hugin Fm, respectively.

The four example factor cubes of FIGS. 3-6 show different indicators of hydrocarbons for the same subsurface region using the same seismic dataset. The degree to which the various indicators are indicative of the presence of hydrocarbons may differ between portions of the subsurface region. One or more embodiments learn the weights to apply and then aggregate the factor cubes according to the weights.

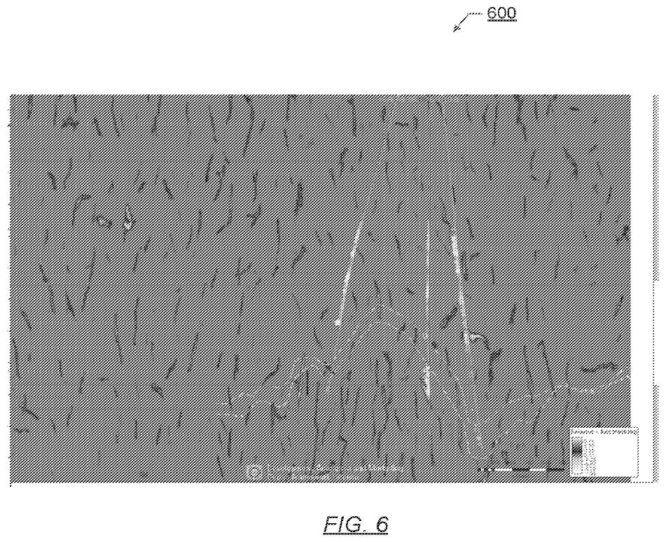

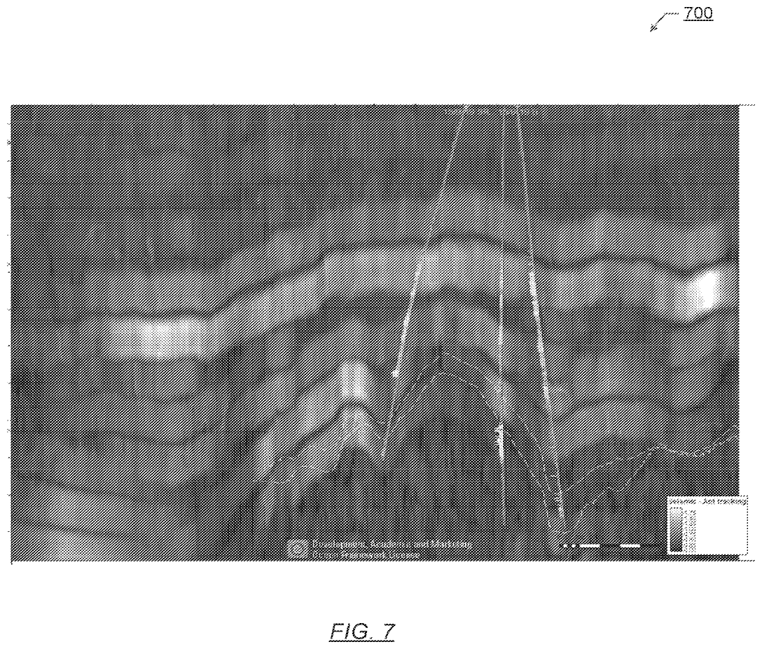

FIG. 7 shows an example cross section of an aggregated cube (700) in accordance with one or more embodiments. The aggregated cube (700) is the weighted sum of FIGS. 3-6 to produce the operator that can indicate hydrocarbons. Bright features are hydrocarbon indications and, in this case, are a good match with hydrocarbon indicators from resistivity logs in wells shown. The reflectors marked show the top and base of Hugin Fm, respectively.

Thus, the data within the cube may be used to control the well equipment used to drill or maintain the well site. For example, the drilling equipment may be adjusted in order to drill into parts of the Earth where the hydrocarbons are indicated to exist. The method further may be used to identify hydrocarbon bearing zones in the seismic data set. As a result, the method may also extend to use the hydrocarbon bearing zones to change, using a computing system, operation of well equipment at a well site. For example, the location of the equipment could be changed, various drilling parameters (speed, velocity, angle, depth, etc.) could be changed, etc. Thus, the one or more embodiments for transforming a non-transitory computer readable storage medium by changing the data structures therein have an application in improving the control of well equipment to produce hydrocarbons or other appropriate fluids from the ground.

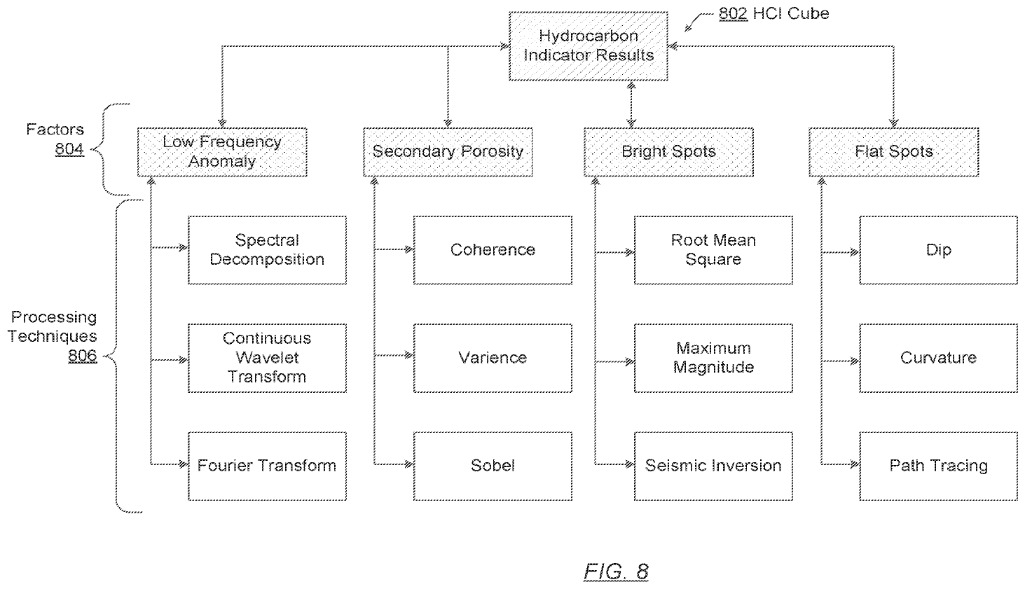

FIG. 8 shows an example diagram of how different processing techniques (806) may be used to generate different types of factor cubes for various factors (804). Performing the aggregation using techniques described herein results in an HCI cube (802) that combines the various techniques. Notably, each of the processing techniques may perform the processing of the factor cubes using a variety of parameters. By varying the values of the parameters, multiple factor cubes may be created. Thus, for example, tens or hundreds of factor cubes may be created for low frequency anomaly by varying the parameters of spectral decomposition, continuous wavelet transformation, and Fourier transform.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 9.1, the computing system (900) may include one or more computer processors (902), non-persistent storage (904), persistent storage (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) may be one or more cores or micro-cores of a processor. The computer processor(s) (902) includes one or more processors. The one or more processors may include a central processing unit (CPU), a graphics processing unit (GPU), a tensor processing unit (TPU), combinations thereof, etc.

The input devices (910) may include a touchscreen, keyboard, mouse, microphone, touchpad, electronic pen, or any other type of input device. The input devices (910) may receive inputs from a user that are responsive to data and messages presented by the output devices (908). The inputs may include text input, audio input, video input, etc., which may be processed and transmitted by the computing system (900) in accordance with the disclosure. The communication interface (908) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the output devices (908) may include a display device, a printer, external storage, or any other output device. One or more of the output devices may be the same or different from the input device(s). The input and output device(s) may be locally or remotely connected to the computer processor(s) (902). Many different types of computing systems exist, and the aforementioned input and output device(s) may take other forms. The output devices (908) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (900) in FIG. 9.1 may be connected to or be a part of a network. For example, as shown in FIG. 9.2, the network (920) may include multiple nodes (e.g., node X (922), node Y (924)). Each node may correspond to a computing system, such as the computing system shown in FIG. 9.1, or a group of nodes combined may correspond to the computing system shown in FIG. 9.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9.1. Further, the client device (926) may include and/or perform all or a portion of one or more embodiments of the invention.

The computing system of FIG. 9.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method comprising:
obtaining seismic data for a subsurface region;
generating, individually for each factor of a plurality of factors, a corresponding set of factor cubes specific to the factor to obtain sets of factor cubes, wherein each factor cube of the plurality of factor cubes comprises a first plurality of cells, the first plurality of cells comprising a value for the factor cube that is for a particular location in the subsurface region, wherein the plurality of factors comprises low frequency anomalies, fracture locations, flat spots distinguishing between oil and cast contacts in the subsurface region, and bright spots having higher amplitude than a surrounding set of locations;
executing an unsupervised machine learning clustering model on the sets of factor cubes to determine a corresponding weight for each factor of the plurality of factors;
aggregating, according to the corresponding weight, the sets of factor cubes to generate an aggregated cube; and
presenting the aggregated cube.

2. The method of claim 1, further comprising:
individually normalizing the factor cubes in the sets of factor cubes to obtain a plurality of normalized factor cubes,
wherein executing the unsupervised machine learning clustering model is on the plurality of normalized factor cubes.

3. The method of claim 1, wherein the unsupervised machine learning clustering model is agglomerative clustering.

4. The method of claim 1, wherein executing the unsupervised machine learning clustering model comprises:
independently for each set of factor cubes of the sets of factor cubes:
iteratively, until a stop condition is reached:
combining at least two factor cubes in the set of factor cubes based on a determined similarity between the at least two factor cubes to form a combined cube,
normalizing the combined cube to create a normalized cube, and
replacing the at least two factor cubes with the normalized cube as a factor cube in the set of factor cubes,
wherein the stop condition is a function of a degree of similarity between factor cubes in the set of factor cubes.

5. The method of claim 4, wherein aggregating, according to the corresponding weight, the sets of factor cubes to generate an aggregated cube comprises:
obtaining, for each set of factor cubes, the normalized cube after the stop condition is reached,
obtaining, as output of the unsupervised machine learning clustering model, a number of factor cubes of an initial corresponding set of factor cubes for the factor that are combined to form the normalized cube and a total number of the initial corresponding set of factor cubes,
wherein the corresponding weight is the number of factor cubes of the initial corresponding set of factor cubes for the factor that are combined to form the normalized cube divided by the total number of the initial corresponding set of factor cubes, and
multiplying the normalized cube after the stop condition is reached by the corresponding weight.

6. The method of claim 1, wherein the aggregated cube comprises a second plurality of cells, the second plurality of cells comprising an aggregated value aggregated across the values of the plurality of cells for the particular location in the subsurface region.

7. The method of claim 1, wherein the aggregated cube is a hydrocarbon indicator cube and wherein the plurality of factor cubes each correspond to hydrocarbon indicator factors.

8. The method of claim 1, wherein aggregating the plurality of factor cubes generates a hydrocarbon indicator cube comprising a second plurality of cells, wherein each cell of the second plurality of cells has a hydrocarbon indicator value aggregated from values for the distinct location of the corresponding cell of a first plurality of cells of a representative factor cube from each set of factor cubes.

9. The method of claim 1, further comprising:
performing spectral decomposition of the seismic data.

10. The method of claim 1, further comprising:
generating a first factor cube of the plurality of factor cubes having frequency values less than fifteen hertz.

11-12. (canceled)

13. A system comprising:
memory; and
a computer processor for performing operations comprising:
obtaining seismic data for a subsurface region,
generating, individually for each factor of a plurality of factors, a corresponding set of factor cubes specific to the factor to obtain sets of factor cubes, wherein each factor cube of the plurality of factor cubes comprises a first plurality of cells, the first plurality of cells comprising a value for the factor cube that is for a particular location in the subsurface region, wherein the plurality of factors comprises low frequency anomalies, fracture locations, flat spots distinguishing between oil and cast contacts in the subsurface region, and bright spots having higher amplitude than a surrounding set of locations,
executing an unsupervised machine learning clustering model on the sets of factor cubes to determine a corresponding weight for each factor of the plurality of factors,
aggregating, according to the corresponding weight, the sets of factor cubes to generate an aggregated cube, and
presenting the aggregated cube.

14-15. (canceled)
